(19) United States
(12) Patent Application Publication
(10) Pub. No.: US 2025/0346041 A1
(43) Pub. Date: Nov. 13, 2025

(54) INK CONTAINER

(71) Applicant: CANON KABUSHIKI KAISHA, Tokyo (JP)

(72) Inventor: HIROAKI MIHARA, Tokyo (JP)

(21) Appl. No.: 19/195,944

(22) Filed: May 1, 2025

(30) Foreign Application Priority Data
May 13, 2024 (JP) 2024-077838

(51) Int. Cl. B41J 2/175; B32B 7/12; B32B 15/085; B32B 15/20; B32B 27/08; B32B 27/32

(52) U.S. Cl. CPC B41J 2/17553; B32B 7/12; B32B 15/085; B32B 15/20; B32B 27/08; B32B 27/32; B41J 2/17523; B32B 2255/10; B32B 2255/205; B32B 2307/31; B32B 2307/7376; B32B 2439/46

(57) ABSTRACT

An ink container that stores ink to be ejected by an ink ejection apparatus includes an ink storage bag made of a laminated sheet and storing the ink therein, and an ink supply member having an ink supply portion for supplying the ink inside the ink storage bag to the ink ejection apparatus. A resin material constituting the laminated sheet contains 90 mass % or more of polyolefin resin.

### BACKGROUND OF THE INVENTION

### Field of the Invention

The present disclosure relates to an ink container.

### Description of the Related Art

Conventionally, ink containers for supplying ink to inkjet recording apparatuses have been widely used. For example, the ink container disclosed in Japanese Patent Application Publication No. 2018-065373 has a flexible bag made of a laminated sheet mainly made of resin, and the bag contains ink to be supplied to the inkjet recording apparatus.

### SUMMARY OF THE INVENTION

In Japanese Patent Application Publication No. 2018-065373, the material of the bag of the ink container is not particularly limited, and the ink container can be formed using multiple types of resin materials such as polyethylene and polyethylene terephthalate (PET).

When considering recycling of materials, polyethylene and PET have significantly different properties, so they need to be separated for recycling. However, since the sheets are strongly bonded with an adhesive or the like, they cannot be easily separated, and the cost of separation is high, making it difficult to recycle the ink container.

The present disclosure provides an ink container with improved recyclability that does not require separation of each layer of the laminated sheet while maintaining high functionality and high reliability as an ink container.

The present disclosure is related to an ink container that stores ink to be ejected by an ink ejection apparatus, the ink container comprising:
an ink storage bag made of a laminated sheet and storing the ink therein; and an ink supply member comprising an ink supply portion for supplying the ink inside the ink storage bag to the ink ejection apparatus, wherein
a resin material constituting the laminated sheet comprises 90 mass % or more of polyolefin resin.

According to the present disclosure, it is possible to provide an ink container with improved recyclability that does not require separation of each layer of the laminated sheet while maintaining high functionality and high reliability as an ink container.

Further features of the present invention will become apparent from the following description of exemplary embodiments with reference to the attached drawings.

### BRIEF DESCRIPTION OF THE DRAWINGS

FIG. 1 is a schematic perspective view of a liquid ejection apparatus;

FIGS. 2A and 2B are a schematic perspective view and a schematic cross-sectional view of an ink container according to an embodiment;

FIG. 3 is a schematic cross-sectional view of a laminated sheet constituting an ink container according to an embodiment;

FIG. 4 is a schematic cross-sectional view of a laminated sheet constituting an ink container according to an embodiment;

FIG. 5 is a schematic perspective view of an ink container according to an embodiment; and

FIG. 6 is a schematic perspective view of an ink container according to an embodiment.

### DESCRIPTION OF THE EMBODIMENTS

In the present disclosure, “from XX to YY” or “XX to YY” indicating a numerical range means a numerical range including a lower limit and an upper limit that are end points unless otherwise specified. In a case where numerical ranges are described in stages, an upper limit and a lower limit of each numerical range can be combined as desired. Furthermore, in the present disclosure, for example, description such as “at least one selected from the group consisting of XX, YY, and ZZ” means any of XX, YY, ZZ, a combination of XX and YY, a combination of XX and ZZ, a combination of YY and ZZ, or a combination of XX, YY, and ZZ. When XX is a group, multiple XXs may be selected from the group, and the same applies to YY and ZZ.

In the present disclosure, “polyolefin resin” refers to a resin containing 50 mass % or more of a monomer unit corresponding to an olefin monomer. “Monomer unit” refers to the reacted form of a monomer substance in a polymer. Polyolefin resin may contain a polymer of an olefin monomer, or may contain a copolymer of a monomer mixture containing an olefin monomer. It is preferable that the polyolefin resin contains 100 mass % of a polymer or copolymer of an olefin monomer.

Below, the embodiments for implementing the technology of the present disclosure will be described with reference to the drawings. Note that the following embodiments do not limit the invention according to the claims, and not all of the combinations of features described in the embodiments are necessarily essential to the solution of the invention.

As described above, when an ink container is formed using multiple types of resin materials, recycling may be difficult. In the present disclosure, in an ink storage bag made of a laminated sheet that stores ink, the resin material constituting the laminated sheet contains 90 mass % or more of polyolefin resin. That is, the resin material contains 90 mass % or more of polyolefin structure. If the resin material contains 90 mass % or more of polyolefin resin, the resin material can be treated as a polyolefin resin when recycling the laminated sheet. As a result, recycling is possible without separating the resin material, such as separating each layer of the laminated sheet.

In addition, polyolefin resins, represented by polypropylene, have high durability and barrier properties, and are also excellent in durability and barrier properties as an ink storage bag.

As described above, the present disclosure provides an ink container with improved recyclability that does not require separation of each layer of the laminated sheet while maintaining high functionality and high reliability as an ink container. The technologies described in this specification have the potential decarbonized society/circular society.

Below, a liquid ejection apparatus such as an ink ejection apparatus to which the ink container can be applied will be described.

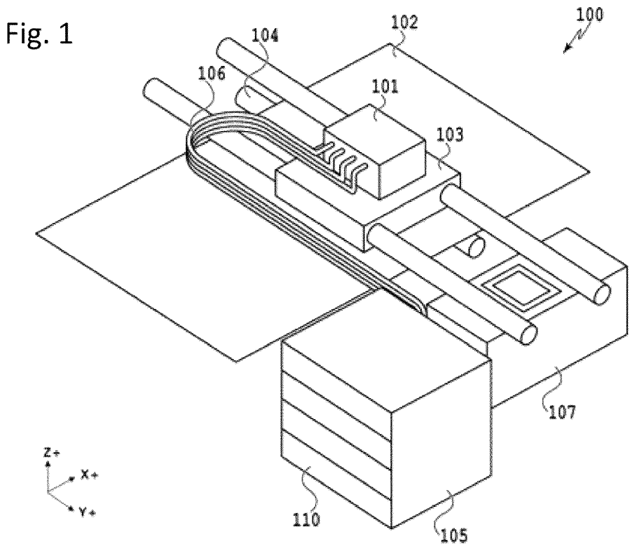

FIG. 1 is a schematic perspective view of a liquid ejection apparatus 100 according to the present embodiment. As shown in FIG. 1, the liquid ejection apparatus 100 includes a liquid ejection head 101, a recording sheet 102, a carriage 103, a conveying roller 104, a liquid supply unit 105, a liquid supply tube 106, and a recovery unit 107.

The liquid ejection apparatus 100 repeats reciprocating movement (main scanning) of the liquid ejection head 101 and conveyance (sub-scanning) of the recording sheet 102, which is a recording medium, at predetermined pitches. In synchronization with these movements, liquids of multiple colors (e.g., ink) are selectively ejected from the liquid ejection head 101, and the liquids land on the recording sheet 102, which is a recording medium, to form characters, symbols, images, and the like.

An example of the liquid ejection apparatus 100 is an inkjet printer. Note that any recording medium may be used as long as it is capable of forming an image by landing ink droplets on the recording medium. For example, recording media of various materials and shapes, such as paper, cloth, optical disk label surfaces, plastic sheets, OHP sheets, and envelopes, can be used.

The liquid ejection head 101 is supported slidably on two guide rails and is mounted on the carriage 103 that moves back and forth in a straight line along the guide rails by a driving means (not shown) such as a motor.

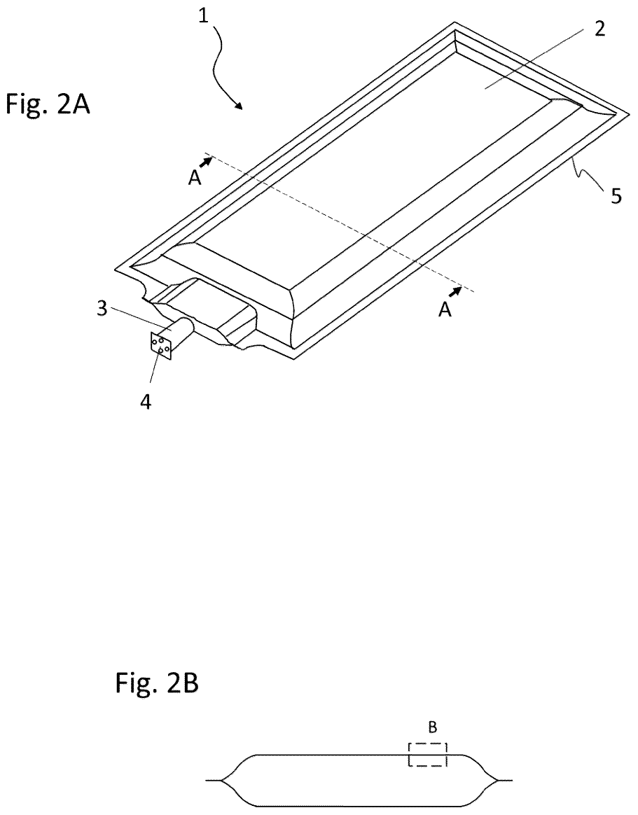

The recording sheet 102 on which liquid ejected from a liquid ejection portion of the liquid ejection head 101 lands is conveyed by the conveying roller 104, which is a conveying means, in a direction that faces the liquid ejection surface of the liquid ejection head 101 and crosses the moving direction of the carriage 103. The liquid ejection head 101 has a plurality of nozzle rows as a plurality of liquid ejection portions, each for ejecting liquid of a different color. A plurality of independent ink containers 1 (see FIGS. 2A and 2B) having liquid outlet members for guiding liquid corresponding to the colors of the liquid ejected from the liquid ejection head 101 are attached to the liquid supply unit 105.

In this embodiment, four ink containers 1, each containing cyan (C), magenta (M), yellow (Y), and black (K) ink, are mounted on the liquid supply unit 105. The four ink containers 1 have the same size, but the ink container 1 for black ink may be larger than the ink containers 1 for the other colors. The liquid ejection head 101 may be mounted on the carriage 103 in a manner that allows for easy attachment and detachment, or in a fixed arrangement.

The liquid supply unit 105 and the liquid ejection head 101 are connected by a plurality of liquid supply tubes 106, each of which corresponds to the color of liquid. By mounting the ink container 1 (see FIGS. 2A and 2B) inside the liquid supply unit 105, it becomes possible to independently supply each color of liquid contained in the ink container 1 to each nozzle row of the liquid ejection head 101. In a non-recording area that is within the reciprocating movement range of the liquid ejection head 101 and outside the passing range of the recording sheet 102, the recovery unit 107 is disposed so as to face the liquid ejection surface of the liquid ejection head 101.

Here, the dimensions shown in the figure will be explained. In this specification, the longitudinal direction of the ink container 1 is called the X direction (length direction), the planar direction perpendicular to the longitudinal direction is called the Y direction (width direction), and the direction perpendicular to the X and Y directions is called the Z direction (height direction). In the X direction, the direction toward the side where the ink container 1 is attached to the liquid supply unit 105 is called the +X direction, and the direction opposite to the +X direction is called the −X direction. In the Y direction, the direction to the left of the direction where the ink container 1 is attached to the liquid supply unit 105 is called the −Y direction, and the direction opposite to the −Y direction is called the +Y direction. In the Z direction, the antigravity direction is called the +Z direction, and the gravity direction is called the −Z direction (FIG. 1).

The recovery unit 107 has a cap portion for capping the liquid ejection surface of the liquid ejection head 101, a suction mechanism for forcibly sucking the liquid while the liquid ejection surface is capped, and a cleaning blade for wiping off dirt from the liquid ejection surface. The above-mentioned suction operation is performed by the recovery unit 107 prior to the recording operation of the liquid ejection apparatus 100. As a result, even if the liquid ejection apparatus 100 is operated after being left unused for a long time, the recovery unit 107 performs a recovery process, allowing the removal of residual air bubbles in the liquid ejection portion of the liquid ejection head 101 and/or thickened liquid near the ejection port. As a result, the ejection characteristics of the liquid ejection head 101 are maintained.

As described above, the liquid ejection apparatus 100 has a function of introducing liquid from the ink container 1 and ejecting the liquid.

The ink container stores the ink to be ejected by the ink ejection apparatus. FIG. 2A shows a schematic perspective view of the ink container. A schematic diagram of the A-A cross-section is shown in FIG. 2B. The ink container 1 is set in the liquid ejection apparatus 100. The ink container has an ink storage bag 2 for storing ink therein, and an ink supply member 3 for supplying ink to the ink ejection apparatus. The ink storage bag is made of a laminated sheet, and is formed into a bag shape by bonding multiple films containing polyolefin resin, for example. Two laminated sheets may be formed into a bag shape, or one sheet may be folded into a bag shape. The laminated sheet may be formed into a bag shape by, for example, heat welding.

The resin material constituting the laminated sheet contains 90 mass % or more of polyolefin resin (polyolefin structure). The resin material also includes an adhesive layer that bonds the sheets in the laminated sheet. From the viewpoint of recyclability, the resin material preferably contains 92 mass % or more of polyolefin resin, more preferably 95 mass % or more, even more preferably 98 mass % or more, and most preferably 99 mass % or more.

There is no particular upper limit, and the resin material may contain 100 mass % of polyolefin resin. The content of polyolefin resin (polyolefin structure) in the resin material is preferably, for example, 90 to 100 mass %, 92 to 100 mass %, 95 to 100 mass %, 98 to 100 mass %, or 99 to 100 mass %.

The polyolefin resin may be at least one selected from the group consisting of a polypropylene resin and a polyethylene resin; a copolymer of ethylene and/or propylene with an olefin monomer other than ethylene and propylene; or the like. The olefin monomer other than ethylene and propylene may, for example, be an α-olefin having 3 to 20 carbon atoms (preferably 4 to 20 carbon atoms).

The polyolefin resin is preferably a polypropylene resin. The polyolefin resin is preferably a polyethylene resin.

The polyolefin resin is preferably subjected to one or both of stretching and electron beam treatment.

The polypropylene resin used in the laminate sheet is at least one selected from the group consisting of unstretched polypropylene, stretched polypropylene, and electron-beam-treated polypropylene. The polypropylene resin is preferably at least one selected from the group consisting of stretched polypropylene, electron-beam-treated polypropylene, and stretched and electron-beam-treated polypropylene.

The polyethylene resin used in the laminate sheet is at least one selected from the group consisting of high-density polyethylene, medium-density polyethylene, low-density polyethylene, stretched high-density polyethylene, stretched medium-density polyethylene, stretched low-density polyethylene, electron-beam-treated high-density polyethylene, electron-beam-treated medium-density polyethylene, and electron-beam-treated low-density polyethylene. The polyethylene resin is preferably at least one selected from the group consisting of high-density polyethylene, medium-density polyethylene, stretched high-density polyethylene, stretched medium-density polyethylene, electron-beam-treated high-density polyethylene, electron-beam-treated medium-density polyethylene, stretched and electron-beam-treated high-density polyethylene, and stretched and electron-beam-treated medium-density polyethylene.

The method for measuring the content of polyolefin resin in the resin material constituting the laminated sheet from the ink container is as follows.

The content of polyolefin resin can be measured by heating up to 600° C. using a pyrolysis GC-MS (GC: 7890B, MS: 5977B, manufactured by Agilent Technologies Inc.).

The ink storage bag 2 is a laminated sheet molded into a bag shape. The ink storage bag 2 is formed into a bag shape by, for example, bonding laminated sheets together near the outer periphery. The laminated sheets are preferably bonded by a method of heating, melting and pressing, but may be bonded by using an adhesive or the like.

The ink supply member 3 has a connection part 4 at its tip that connects to the ink ejection apparatus. The connection part 4 preferably has a check valve function to prevent the ink supplied to the ink ejection apparatus from flowing backward. The material constituting the ink supply member 3 may be a resin such as polyolefin resin, polyester resin, or polyamide resin, a metal, an inorganic material, or a composite material thereof. In consideration of recyclability, it is preferable to form the ink supply member 3 from polyolefin resin, which is the same material as the ink storage bag 2. In other words, the ink supply member 3 preferably contains a polyolefin resin.

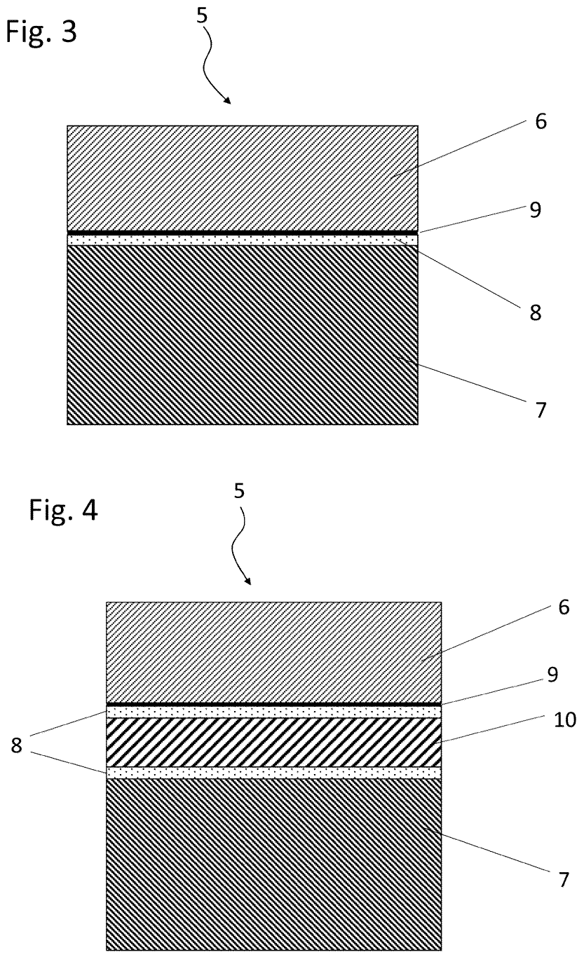

The layer structure of the laminated sheet is not particularly limited. For example, the laminated sheet has a protective layer and a sealing layer. An adhesive layer may be provided between the protective layer and the sealing layer. In addition, a gas barrier layer may be provided between the protective layer and the sealing layer from the viewpoint of imparting gas barrier properties. FIG. 3 shows an example of the laminated sheet 5 constituting the ink storage bag 2. FIG. 4 shows another example of the laminated sheet 5 constituting the ink storage bag 2 (these are enlarged views of part B in FIG. 2B).

The laminated sheet 5 in FIG. 3 has a protective layer 6, a gas barrier layer 9, an adhesive layer 8, and a sealing layer 7 in this order. The laminated sheet 5 may have a protective layer 6, an adhesive layer 8, a gas barrier layer 9, an adhesive layer 8, and a sealing layer 7 in this order. The laminated sheet 5 in FIG. 4 has a protective layer 6, a gas barrier layer 9, an adhesive layer 8, an adjustment layer 10, an adhesive layer 8, and a sealing layer 7 in this order.

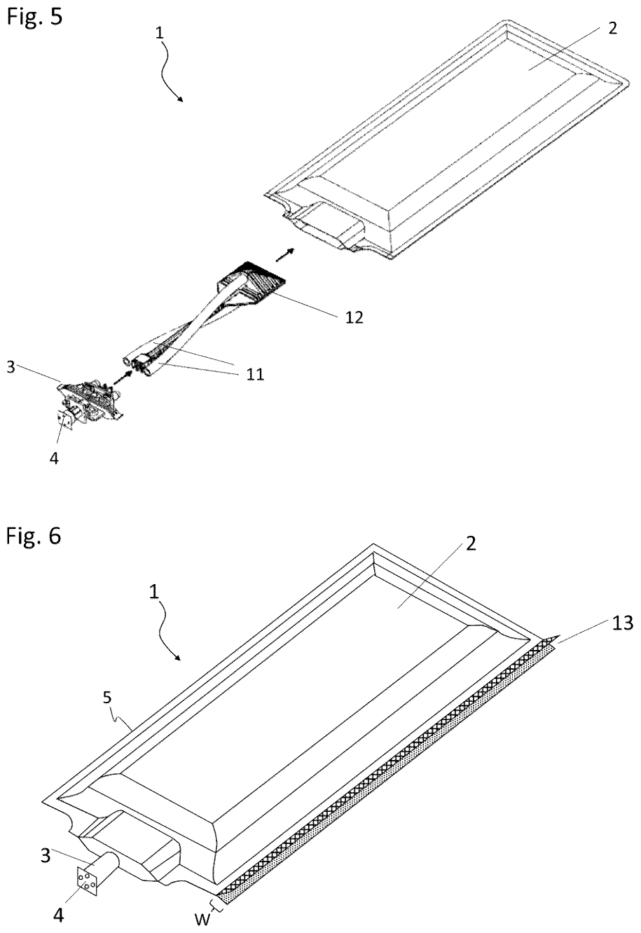

As shown in FIG. 5, the ink container 1 preferably has an ink supply tube 11 arranged in the ink container and connected to the ink supply portion, and a spacer member connected to the ink supply tube 11 and having a liquid inlet port for introducing the ink in the ink storage bag 2 to the ink supply portion via the ink supply tube 11.

The ink supply tube and the spacer member preferably contain 90 mass % or more of polyolefin resin. In this configuration, when the ink container 1 is recycled after the ink has been used up, the constituent materials can be recycled as olefin materials, so that recyclability is significantly improved.

The polyolefin resin in the ink supply tube and the spacer member is preferably the same type as the resin material in the laminated sheet.

The spacer member preferably has at least two liquid inlet ports at different positions in the height direction in a given posture. This makes it difficult for the ink composition to become biased.

The type and content of the polyolefin resin in the ink supply tube and the spacer member are the same as the resin material in the laminated sheet described above. For example, the content of the polyolefin resin is preferably 90 to 100 mass %, 92 to 100 mass %, 95 to 100 mass %, 98 to 100 mass %, or 99 to 100 mass %. In addition, it is preferable that the polyolefin resin is unstretched.

As shown in FIG. 6, the ink container 1 preferably has a gripping area 13 capable of gripping the laminated sheet 5 at least in a part of the outer periphery of the ink storage bag 2. For example, by providing an unbonded area of the laminated sheets at the end of the ink storage bag formed by bonding the laminated sheets together, the unbonded area can be used as the gripping area 13. The bonded laminated sheets can be peeled apart by gripping the gripping area 13. As a result, it becomes easier to wash the inside of the ink container 1 when the ink is used up and the interior is washed.

The gripping area preferably has a width ranging from 2 mm to 20 mm, more preferably from 5 mm to 10 mm. The presence of such a gripping area 13 further improves recyclability. In FIG. 6, the width of the gripping area is the length indicated by W.

### Protective Layer

The laminated sheet may have a protective layer. The protective layer 6 protects the ink container 1 against external impacts, for example. As shown in FIG. 3 and FIG. 4, the protective layer 6 is preferably disposed on the outermost layer of the ink storage bag. The protective layer 6 includes the above-mentioned polyolefin resin.

Furthermore, from the viewpoint of further improving durability, the protective layer 6 preferably contains at least one selected from the group consisting of stretched polypropylene, electron-beam-treated polypropylene, stretched and electron-beam-treated polypropylene, high-density polyethylene, medium-density polyethylene, stretched high-density polyethylene, stretched medium-density polyethylene, electron-beam-treated high-density polyethylene, electron-beam-treated medium-density polyethylene, stretched and electron-beam-treated high-density polyethylene, and stretched and electron-beam-treated medium-density polyethylene.

The protective layer 6 may have various additives. The additives include, for example, a crosslinking agent, an antioxidant, an antiblocking agent, an ultraviolet absorber, a lubricant, a light stabilizer, a filler, a reinforcing agent, an antistatic agent, a pigment, a modifier, and the like.

The polyolefin may be stretched. When the stretching treatment is performed, the film may be uniaxially stretched or biaxially stretched.

The stretching ratio in the longitudinal direction (MD) is preferably from 2 to 10 times, and more preferably from 3 to 7 times. By setting the stretching ratio in the longitudinal direction (MD) to 2 times or more, durability can be further improved.

From the viewpoint of the breaking limit, the upper limit of the stretching ratio in the longitudinal direction (MD) is preferably 10 times or less.

Furthermore, the stretching ratio in the transverse direction (TD) is preferably from 2 to 10 times, and more preferably from 3 to 7 times. By setting the stretching ratio in the transverse direction (TD) of the substrate to 2 times or more, durability can be further improved. From the viewpoint of the breaking limit, the upper limit of the stretching ratio in the transverse direction (TD) is preferably 10 times or less.

The orientation degree can be changed by performing the stretching treatment. The orientation degree is preferably 60% or more, and more preferably 90% or more.

The polyolefin may be subjected to electron beam treatment. When electron beam treatment is performed, the dose of the electron beam is preferably in the range of from 10 kGy to 2000 kGy, more preferably in the range of from 20 kGy to 1000 kGy, and more preferably in the range of from 150 kGy to 500 kGy. The acceleration voltage of the electron beam is preferably in the range of from 30 kV to 300 kV, more preferably in the range of from 50 kV to 300 kV, and even more preferably in the range of from 70 kV to 250 kV. The irradiation energy of the electron beam is preferably in the range of from 20 keV to 750 keV, more preferably in the range of from 25 keV to 500 keV, and particularly preferably in the range of from 30 keV to 200 keV.

The oxygen concentration in the electron beam irradiation apparatus is preferably 500 ppm or less, and more preferably 100 ppm or less. By performing electron beam irradiation under such conditions, it is possible to suppress the generation of ozone, and also to prevent the radicals generated by electron beam irradiation from being deactivated by the oxygen in the atmosphere. Such conditions can be achieved, for example, by maintaining an inert gas atmosphere (e.g., nitrogen or argon) within the apparatus.

By performing electron beam treatment, the crosslink density is improved and the resin becomes stronger, so that durability is further improved. The gel fraction as an index for measuring the crosslink density is preferably from 15% to 90%, more preferably from 20% to 80%.

The protective layer satisfies at least one of (1) the orientation degree of the protective layer is 60% or more, and (2) the gel fraction of the protective layer is 15% or more. Both may be satisfied. By satisfying the above-mentioned orientation degree and/or gel fraction, the durability of the ink container is further improved, and it becomes easier to achieve both recyclability and durability. The orientation degree of the protective layer is preferably 60 to 100%, more preferably 90 to 100%. The gel fraction of the protective layer is preferably 15 to 90%, more preferably 20 to 80%, even more preferably 30 to 80%, and most preferably 40 to 60%.

The orientation degree is calculated by X-ray diffraction analysis from the formula: Orientation degree F[%]=(360ΣW)/360×100

where W represents the full width at half maximum.

The X-ray diffraction analysis was performed using an Empyrean manufactured by Malvern Panalytical Co., Ltd. under the following conditions:
X-ray: Cu-Kα ray (50 kV, 200 mA)
Step angle: 0.04°
Scan range: 2θ=5 to 40°

The gel fraction is measured by the method of JIS K 6796. Specifically, the resin layer is precisely weighed, then wrapped in a 120 to 150 mesh wire net, and the sample wrapped in the wire net is immersed in a flask containing xylene. A cooling tube is attached to the flask, and the xylene is boiled for 8 hours, after which the resin layer wrapped in the wire net is removed from the flask and completely dried. The resin layer wrapped in the wire net is precisely weighed, and the gel fraction is calculated using the following formula:

$$Gel fraction = ( mass of resin layer after immersion and drying ) / ( mass of resin layer before immersion ) \times 100$$

The protective layer 6 may also be surface-treated. This can improve the adhesion with adjacent layers. The method of surface treatment is not particularly limited, and examples include physical treatments such as corona discharge treatment, ozone treatment, low-temperature plasma treatment using various gases, and glow discharge treatment, as well as chemical treatments such as oxidation treatment using chemicals.

An image may be printed on the surface of the protective layer 6, and the image is not particularly limited, and may be a character, a pattern, a symbol, or a combination thereof.

The thickness of the protective layer 6 is preferably from 10 μm to 150 μm, more preferably from 30 μm to 100 μm. By making the thickness 10 μm or more, the durability can be improved. By making the thickness 150 μm or less, the processability of the laminated sheet can be improved.

The thickness of each layer in the laminated sheet is measured by embedding the sheet in epoxy resin or the like, cutting the cross-section with Microtome (Leica RM2165), and observing the cross-section with a metallurgical microscope. Sealing Layer

The laminated sheet may have a sealing layer. As shown in FIGS. 4 and 5, the sealing layer 7 is preferably disposed on the innermost layer of the ink storage bag. The sealing layer can be heat-welded to form the ink storage bag. For example, the sealing layers are bonded together by heat welding to form a bag, forming an ink storage bag. The sealing layer is a layer that comes into direct contact with the ink when the ink is contained in the bag.

The sealing layer 7 preferably contains the above-mentioned polyolefin resin. The sealing layer 7 preferably contains a polyolefin resin that has not been stretched or electron-beam-treated. The polyethylene is preferably medium-density polyethylene or low-density polyethylene. From the viewpoint of heat welding, the sealing layer preferably contains at least one selected from the group consisting of unstretched polypropylene, medium-density polyethylene, and low-density polyethylene, and more preferably consists of at least one selected from the group consisting of unstretched polypropylene, medium-density polyethylene, and low-density polyethylene.

When the sealing layers 7 are bonded together by heat sealing, it is preferable that they have a lower heat resistance than the protective layer 6. For example, when polypropylene is used for the protective layer 6, it is preferable to use polypropylene that has not been stretched or electron-beam-treated, or various types of polyethylene for the sealing layer 7. When the protective layer 6 is made of polyethylene, it is preferable that the sealing layer 7 is made of medium-density polyethylene or low-density polyethylene that has not been stretched or electron-beam-treated.

When the sealing layers 7 are bonded together with an adhesive, the sealing layer 7 may contain a polyolefin resin.

The sealing layer 7 may contain various additives. Examples of the additives include crosslinking agents, antioxidants, antiblocking agents, UV absorbers, lubricants, light stabilizers, fillers, reinforcing agents, antistatic agents, pigments, and modifiers.

The thickness of the sealing layer 7 is preferably from 30 μm to 200 μm, and more preferably from 50 μm to 150 μm. By making the thickness 30 μm or more, the strength can be further improved. In addition, by making the thickness 200 μm or less, the processability of the laminated sheet 5 can be improved.

### Adhesive Layer

The laminated sheet may have an adhesive layer between the layers of the laminated sheet. The layers of the laminated sheets are bonded together. The laminated sheet may have an adhesive layer, for example, between the protective layer 6 and the sealing layer 7. In addition, in the case of FIG. 3, the laminated sheet has an adhesive layer 8 between the gas barrier layer 9 and the sealing layer 7. In addition, in the case of FIG. 4, the laminated sheet 5 has an adhesive layer 8 between the gas barrier layer 9 and the adjustment layer 10, and between the adjustment layer 10 and the sealing layer 7.

The adhesive layer 8 preferably contains a polyolefin resin. The polyolefin resin preferably contains at least one selected from the group consisting of a polypropylene resin and a polyethylene resin. The adhesive layer 8 preferably contains a monomer unit corresponding to an unsaturated carboxylic acid and an unsaturated carboxylic anhydride as at least one copolymerization component selected from the group consisting of a polypropylene resin and a polyethylene resin.

By using an unsaturated carboxylic acid and an unsaturated carboxylic anhydride as a copolymerization component of the polyolefin resin in the adhesive layer, the adhesive layer contains a carboxy group. This increases the polarity and improves the adhesiveness. The content of these copolymerization components may be in a range in which the content of polyolefin resin in the resin material constituting the laminated sheet is 90 mass % or more.

When the adhesive layer 8 contains a polyethylene resin, the polyethylene resin preferably contains from 0.01 mass % to 5 mass % of a monomer unit corresponding to an unsaturated carboxylic acid and an unsaturated carboxylic anhydride as a copolymerization component. When the adhesive layer 8 is a polypropylene resin, the polypropylene resin preferably contains 0.01 to 5 mass % of a monomer unit corresponding to an unsaturated carboxylic acid and an unsaturated carboxylic anhydride as a copolymerization component.

When the adhesive layer 8 contains a polyethylene resin, the content of the ethylene component in the polyethylene resin is preferably 50 to 99.9 mass %, and more preferably 90 to 99 mass %. When the adhesive layer 8 contains a polypropylene resin, the content of the propylene component in the polypropylene resin is preferably 50 to 99.9 mass %, and more preferably 90 to 99 mass %.

The unsaturated carboxylic acid used as the copolymerization component may be at least one selected from the group consisting of acrylic acid, methacrylic acid, maleic acid, itaconic acid, fumaric acid, crotonic acid, and the like. The unsaturated carboxylic acid anhydride may be an anhydride of the above-mentioned unsaturated carboxylic acid, such as maleic anhydride or itaconic anhydride.

The weight-average molecular weight of the polyethylene polymer is preferably from 20,000 to 100,000, and more preferably from 25,000 to 70,000. The weight average molecular weight of the polypropylene polymer is preferably from 5,000 to 150,000, more preferably from 20,000 to 120,000.

The adhesive layer 8 may contain additives such as pigments such as titanium oxide, zinc oxide, and carbon black, dyes such as disperse dyes, acid dyes, and cationic dyes, antioxidants, lubricants, colorants, stabilizers, wetting agents, thickeners, coagulants, gelling agents, anti-settling agents, softeners, plasticizers, leveling agents, ultraviolet absorbers, and flame retardants.

The thickness of the adhesive layer 8 is preferably from 0.05 μm to 1.0 μm, more preferably from 0.1 μm to 0.7 μm, and even more preferably from 0.1 μm to 0.5 μm. By making the thickness of the adhesive layer 0.05 μm or more, the adhesion between the layers can be further improved, and the resistance to contents can be further improved. Also, by making the thickness of the adhesive layer 1 μm or less, insufficient drying can be prevented.

The adhesive layer can be formed by applying and then drying using, for example, a gravure roll coating method, a reverse roll coating method, a wire bar coating method, a lip coating method, an air knife coating method, a curtain flow coating method, or a spray coating method.

### Barrier Layer

The laminated sheet may have a barrier layer 9. The laminated sheet preferably has a barrier layer between the layers of the laminated sheet. For example, the laminated sheet has at least a protective layer, a barrier layer, and a sealing layer in this order. Other layers may be provided between respective layers. For example, an adhesive layer may be provided between the barrier layer and the sealing layer. The barrier layer 9 prevents the ink components in the ink container 1 from volatilizing and leaking to the outside, and also prevents external gas from penetrating through the laminated sheet 5 of the ink container 1 and entering it.

The barrier layer 9 is preferably a metal foil or a vapor-deposited film. The barrier layer 9 is composed of a metal foil such as aluminum, or a metal like aluminum, as well as a vapor-deposited film of inorganic oxides including aluminum oxide, silicon oxide, magnesium oxide, calcium oxide, zirconium oxide, titanium oxide, boron oxide, hafnium oxide, and barium oxide. The barrier layer 9 preferably contains at least one selected from the group consisting of aluminum and inorganic oxides. More preferably, the barrier layer 9 is an aluminum foil or at least one vapor-deposited film selected from the group consisting of aluminum and inorganic oxides. The inorganic oxide is preferably silicon oxide.

The thickness of the metal foil, such as aluminum foil, is preferably from 2 μm to 20 μm, more preferably from 6 μm to 12 μm. The thickness of the vapor-deposited film is preferably from 1 nm to 150 nm, more preferably from 5 nm to 60 nm, and even more preferably from 10 nm to 40 nm.

The above-mentioned metals or inorganic oxides are difficult to recycle together with resin materials, but they can be recycled because they are used in small amounts relative to the total amount of constituent materials. Thus, the use of various vapor-deposited films is slightly inferior to aluminum foil in terms of gas barrier properties, but is excellent in recyclability because less material is used. The barrier layer 9 is preferably disposed at a position other than the outermost or innermost position.

### Adjustment Layer

The laminated sheet may have an adjustment layer between the layers of the laminated sheet. The adjustment layer 10 shown in FIG. 4 is used for adjusting strength, for example. The adjustment layer 10 preferably contains at least one selected from the group consisting of a polypropylene resin and a polyethylene resin, which are polyolefin resins. The adjustment layer 10 preferably contains a polyolefin resin that has been subjected to one or both of stretching and electron beam treatment. For example, desirable materials include stretched polypropylene, electron-beam-treated polypropylene, high-density polyethylene, medium-density polyethylene, stretched high-density polyethylene, medium-density polyethylene, low-density polyethylene, electron-beam-treated high-density polyethylene, medium-density polyethylene, low-density polyethylene.

The above-mentioned copolymer of ethylene and/or propylene with an olefin monomer other than ethylene and propylene may also be used. The adjustment layer may also contain a resin other than a polyolefin resin, specifically a resin such as a polyester resin, a polyamide resin, a vinyl resin, or a polyurethane resin. However, the resin material constituting the laminate sheet must contain 90 mass % or more of polyolefin resin.

The adjustment layer may contain various additives. Examples of additives include crosslinking agents, antioxidants, antiblocking agents, UV absorbers, lubricants, light stabilizers, fillers, reinforcing agents, antistatic agents, pigments, and modifiers.

The polyolefin may be stretched. When stretched, the film may be uniaxially stretched or biaxially stretched.

The stretching ratio in the longitudinal direction (MD) is preferably from 2 to 10 times, and more preferably from 3 to 7 times. By setting the stretching ratio in the longitudinal direction (MD) to 2 times or more, durability can be further improved. From the viewpoint of the breaking limit, the upper limit of the stretching ratio in the longitudinal direction (MD) is preferably 10 times or less.

Furthermore, the stretching ratio in the transverse direction (TD) is preferably from 2 to 10 times, and more preferably from 3 to 7 times. By setting the stretching ratio in the transverse direction (TD) of the substrate to 2 times or more, durability can be further improved. The upper limit of the stretching ratio in the transverse direction (TD) is preferably 10 times or less from the viewpoint of the breaking limit.

The polyolefin may be electron-beam-treated. When the electron beam treatment is performed, the dose of the electron beam to be irradiated is preferably in the range of from 10 kGy to 2,000 kGy, more preferably in the range of from 20 kGy to 1,000 kGy, and more preferably in the range of from 150 kGy to 500 kGy. The acceleration voltage of the electron beam is preferably in the range of from 30 kV to 300 kV, more preferably in the range of from 50 kV to 300 kV, and even more preferably in the range of from 50 kV to 250 kV. The irradiation energy of the electron beam is preferably in the range of from 20 keV to 750 keV, more preferably in the range of from 25 keV to 500 keV, and particularly preferably in the range of from 30 keV to 200 keV.

The oxygen concentration in the electron beam irradiation apparatus is preferably 500 ppm or less, more preferably 100 ppm or less. By performing electron beam irradiation under such conditions, it is possible to suppress the generation of ozone, and also to prevent the radicals generated by electron beam irradiation from being deactivated by the oxygen in the atmosphere. Such conditions can be achieved, for example, by maintaining an inert gas atmosphere (e.g., nitrogen or argon) within the apparatus.

The adjustment layer 10 may also be subjected to a surface treatment. This can improve the adhesion with adjacent layers. The method of surface treatment is not particularly limited, and examples include physical treatments such as corona discharge treatment, ozone treatment, low-temperature plasma treatment using various gases, and glow discharge treatment, as well as chemical treatments such as oxidation treatment using chemicals.

An image may be printed on the surface of the adjustment layer 10, and the image is not particularly limited, and may be a character, a pattern, a symbol, or a combination thereof.

The thickness of the adjustment layer 10 is preferably from 10 μm to 100 μm, and more preferably from 20 μm to 50 μm.

While FIG. 4 shows an example in which there is one adjustment layer 10, there may be multiple adjustment layers 10. In addition, while FIG. 4 shows the adjustment layer 10 in the middle of the layers, the adjustment layer 10 may be located at the outermost part of the layers.

### EXAMPLES

The following examples will be used to explain the present disclosure in detail, but the present disclosure is not limited to these.

Table 1 shows the layer structures of the laminated sheets of Examples 1 to 12 and Comparative Examples 1 to 4.

In Example 1, a laminated sheet having an adhesive layer between the protective layer and the barrier layer in the layer structure shown in FIG. 3 was obtained. As the protective layer 6, a high-density polyethylene (HDPE film manufactured by Wako Plastics Industries Co., Ltd.) having a thickness of 60 μm and having been subjected to a stretching treatment (5 times in both MD and TD) was used. The orientation degree was 95%. The orientation degree was determined by the above-mentioned procedure.

Also, an aluminum foil having a thickness of 6 μm was used as the barrier layer 9. As the sealing layer 7, a low-density polyethylene (LDPE film manufactured by Wako Plastics Industries Co., Ltd.) having a thickness of 150 μm was used. The adhesive layer 8 between respective layers was formed by coating a polyethylene polymer (SB-1200 manufactured by Unitika) containing 0.01 to 5 mass % of a monomer unit corresponding to an unsaturated carboxylic acid or an anhydride thereof, such as (meth) acrylic acid, maleic acid, itaconic acid, fumaric acid, or crotonic acid, to a thickness of 0.5 μm by roll coating and then drying. The layers were bonded together by the adhesive layer to obtain the laminated sheet of this example.

In Example 2, a polypropylene (OPP manufactured by Seiwa Film Group Co., Ltd.) having a thickness of 60 μm and having been subjected to a stretching treatment (5 times in both MD and TD) was used as the protective layer 6. The orientation degree was 95%. The sealing layer 7 was made of an unstretched polypropylene (CPP manufactured by Seiwa Film Group Co., Ltd.) having a thickness of 80 μm. As the adhesive layer 8 between respective layers, a polypropylene polymer (DA-1010 manufactured by Unitika) containing 0.01 to 5 mass % of a monomer unit corresponding to an unsaturated carboxylic acid or an anhydride thereof, such as (meth) acrylic acid, maleic acid, itaconic acid, fumaric acid, or crotonic acid, was formed to a thickness of 0.5 μm. The remaining layers were formed in the same manner as in Example 1 to form the laminated sheet.

In Example 3, a laminated sheet having a layer structure shown in FIG. 3 was obtained. In Example 3, a 30 nm aluminum vapor deposition was formed on the protective layer as the barrier layer 9. An adhesive layer was not used between the protective layer 6 and the barrier layer 9. The remaining layers were formed in the same manner as in Example 2 to form the laminated sheet.

In Example 4, a 30 nm silicon oxide vapor deposition was formed on the protective layer 6 as the barrier layer 9. The remaining layers were formed in the same manner as in Example 3 to form the laminated sheet.

In Example 5, a 30 nm silicon oxide vapor deposition was formed on the protective layer 6 as the barrier layer 9. An adhesive layer was not used between the protective layer 6 and the barrier layer 9. The remaining layers were formed in the same manner as in Example 1 to form the laminated sheet.

In Example 6, a 60 μm-thick polypropylene that had been subjected to electron beam treatment was used as the protective layer 6. The conditions for the electron beam irradiation include a dose of 200 kGy, an accelerating voltage of the electron beam of 100 kV, an irradiation energy of the electron beam of 100 keV, and an oxygen concentration of 80 ppm in the electron beam irradiation apparatus. At this time, the gel fraction was 45%. The gel fraction was measured by the method of JIS K 6796. The remaining layers were formed in the same manner as in Example 4 to form the laminated sheet.

In Example 7, a 150 μm-thick low-density polyethylene was used as the sealing layer 7. The remaining layers were formed in the same manner as in Example 4 to form the laminated sheet.

In Example 8, a polypropylene polymer (DA-1010 manufactured by Unitika) containing 0.01 to 5 mass % of a monomer unit corresponding to an unsaturated carboxylic acid or its anhydride was formed as the adhesive layer 8 between the protective layer 6 and the barrier layer 9 to a thickness of 0.5 μm. The remaining layers were formed in the same manner as in Example 4 to form the laminated sheet.

In Example 9, a polypropylene having a thickness of 60 μm, which had been stretched and then subjected to electron beam treatment, was used as the protective layer 6. That is, the polypropylene of the protective layer in Example 2 was subjected to electron beam treatment in the same manner as in Example 6. The remaining layers were formed in the same manner as in Example 4 to form the laminated sheet.

In Example 10, an adjustment layer 10 was provided between the barrier layer 9 and the sealing layer 7 via an adhesive layer 8. A polypropylene having a thickness of 30 μm and having been stretched (OPP manufactured by Sewa Film Group Co., Ltd.) was used as the adjustment layer 10. The remaining layers were formed in the same manner as in Example 4 to form the laminated sheet.

In Example 11, the layers were the same as in Example 10, but the protective layer 6 and the adjustment layer 10 were made of resin with an orientation degree of 60% (both protective layer and adjustment layer: OPP manufactured by Sewa Film Group Co., Ltd.).

In Example 12, the layers were the same as in Example 11 except for the adjustment layer 10, but a 10 μm-thick nylon was arranged in the adjustment layer 10. This improved durability compared to Example 11. The polyolefin resin content in the resin material constituting the laminated sheet was 92 mass %, but it was recyclable.

In Comparative Example 1, a 12 μm-thick PET (E5200 manufactured by Toyobo Co., Ltd.) was used for the protective layer 6. A 3 μm-thick polyurethane adhesive (Uprene UXA-307 manufactured by Sanyo Chemical Industries Co., Ltd.) was used for the adhesive layer 8. An aluminum foil with a thickness of 6 μm was used for the barrier layer 9. The adjustment layer 10 was made of nylon (N2102 manufactured by Toyobo Co., Ltd.) having a thickness of 25 μm. The sealing layer 7 was made of low-density polyethylene (LDPE film manufactured by Wako Plastics Co., Ltd.) having a thickness of 150 μm.

In Comparative Example 2, a silicon oxide film was deposited to a thickness of 30 nm on the protective layer as the barrier layer 9, and no adhesive layer was used between the protective layer and the barrier layer. The remaining layers were formed in the same manner as in Comparative Example 1 to form the laminated sheet.

In Comparative Example 3, a polypropylene film (OPP manufactured by Sewa Film Group Co., Ltd.) having a thickness of 30 μm and having been stretched was used as the protective layer 6. Furthermore, a nylon film (N2102 manufactured by Toyobo Co., Ltd.) having a thickness of 25 μm was used as the adjustment layer 10. Furthermore, a polyurethane-based adhesive (Uprene UXA-307 manufactured by Sanyo Chemical Industries Co., Ltd.) having a thickness of 3 μm was used as the adhesive layer 8 between the adjustment layer 10 and the sealing layer. The remaining layers were formed in the same manner as in Example 4 to form the laminated sheet.

In Comparative Example 4, a 25 μm-thick nylon (N2102 manufactured by Toyobo Co., Ltd.) adjustment layer and a 0.5 μm-thick PE adhesive (SB-1200 manufactured by Unitika Co., Ltd.) were added to the configuration of Example 5. The olefin resin content was 87 mass %. Comparative Example 4 was rated C for recyclability.

TABLE 1

| | Laminate structure | | | | | | | | | |
|---|---|---|---|---|---|---|---|---|---|---|
| | Protective layer | | Adhesive layer | | Barrier layer | | | Adhesive layer | | |
| | Material | Thickness | Material | Thickness | Material | Thickness | | Material | Thickness | |
| Example 1 | High-density PE_stretching | 60 μm | PE adhesive | 0.5 μm | Aluminum foil | 6 | μm | PE adhesive | 0.5 | μm |
| | (orientation degree 95%) | | | | | | | | | |
| Example 2 | PP_stretching | 60 μm | PP adhesive | 0.5 μm | Aluminum foil | 6 | μm | PP adhesive | 0.5 | μm |
| | (orientation degree 95%) | | | | | | | | | |
| Example 3 | PP_stretching | 60 μm | — | — | Aluminum vapor | 30 | nm | PP adhesive | 0.5 | μm |
| | (orientation degree 95%) | | | | deposition | | | | | |
| Example 4 | PP_stretching | 60 μm | — | — | SiO deposition | 30 | nm | PP adhesive | 0.5 | μm |
| | (orientation degree 95%) | | | | | | | | | |
| Example 5 | High-density PE_stretching | 60 μm | — | — | SiO deposition | 30 | nm | PE adhesive | 0.5 | μm |
| | (orientation degree 95%) | | | | | | | | | |
| Example 6 | PP_electron beam | 60 μm | — | — | SiO deposition | 30 | nm | PP adhesive | 0.5 | μm |
| | (gel fraction 45%) | | | | | | | | | |
| Example 7 | PP_stretching | 60 μm | — | — | SiO deposition | 30 | nm | PP adhesive | 0.5 | μm |
| | (orientation degree 95%) | | | | | | | | | |
| Example 8 | PP_stretching | 60 μm | PP adhesive | 0.5 μm | SiO deposition | 30 | nm | PP adhesive | 0.5 | μm |
| | (orientation degree 95%) | | | | | | | | | |
| Example 9 | PP_stretching and electron beam | 60 μm | — | — | SiO deposition | 30 | nm | PP adhesive | 0.5 | μm |
| | (orientation degree 95%, gel | | | | | | | | | |
| | fraction 45%) | | | | | | | | | |
| Example 10 | PP_stretching | 60 μm | — | — | SiO deposition | 30 | nm | PP adhesive | 0.5 | μm |
| | (orientation degree 95%) | | | | | | | | | |
| Example 11 | PP_stretching | 60 μm | — | — | SiO deposition | 30 | nm | PP adhesive | 0.5 | μm |
| | (orientation degree 60%) | | | | | | | | | |
| Example 12 | PP_stretching | 60 μm | — | — | SiO deposition | 30 | nm | PP adhesive | 0.5 | μm |
| | (orientation degree 95%) | | | | | | | | | |
| Comparative | PET | 12 μm | Polyurethane | 3 μm | Aluminum foil | 6 | μm | Polyurethane | 3 | μm |
| Example 1 | | | | | | | | | | |
| Comparative | PET | 12 μm | — | — | SiO deposition | 30 | nm | Polyurethane | 3 | μm |
| Example 2 | | | | | | | | | | |
| Comparative | PP_stretching | 30 μm | — | — | SiO deposition | 30 | nm | PP adhesive | 0.5 | μm |
| Example 3 | (orientation degree 95%) | | | | | | | | | |
| Comparative | High-density PE_stretching | 60 μm | — | — | SiO deposition | 30 | nm | PE adhesive | 0.5 | μm |
| Example 4 | (orientation degree 95%) | | | | | | | | | |

| | Laminate structure | | | | | | | | | Evaluation results | | |
|---|---|---|---|---|---|---|---|---|---|---|---|---|
| | Adjustment layer | | Adhesive layer | | | Sealing layer | | | | | Barrier | |
| | Material | Thickness | Material | Thickness | | Material | Thickness | | A | Durability | properties | Recyclability |
| Example 1 | — | — | — | — | | Low-density | 150 | μm | 99 | B | A | B |
| | | | | | | PE | | | | | | |
| Example 2 | — | — | — | — | | Unstretched | 80 | μm | 99 | B | A | B |
| | | | | | | PP | | | | | | |
| Example 3 | — | — | — | — | | Unstretched | 80 | μm | 99 | B | B | A |
| | | | | | | PP | | | | | | |
| Example 4 | — | — | — | — | | Unstretched | 80 | μm | 99 | B | B | A |
| | | | | | | PP | | | | | | |
| Example 5 | — | — | — | — | | Low-density | 150 | μm | 99 | B | B | A |
| | | | | | | PE | | | | | | |
| Example 6 | — | — | — | — | | Unstretched | 80 | μm | 99 | B | B | A |
| | | | | | | PP | | | | | | |
| Example 7 | — | — | — | — | | Low-density | 150 | μm | 99 | B | B | A |
| | | | | | | PE | | | | | | |
| Example 8 | — | — | — | — | | Unstretched | 80 | μm | 99 | B | B | A |
| | | | | | | PF | | | | | | |
| Example 9 | — | — | — | — | | Unstretched | 80 | μm | 99 | A | B | A |
| | | | | | | PP | | | | | | |
| Example 10 | PP_stretching | 30 μm | PP adhesive | 0.5 | μm | Unstretched | 80 | μm | 99 | A | B | A |
| | (orientation | | | | | PP | | | | | | |
| | degree 95%) | | | | | | | | | | | |
| Example 11 | PP_stretching | 30 μm | PP adhesive | 0.5 | μm | Unstretched | 80 | μm | 99 | B | B | A |
| | (orientation | | | | | PP | | | | | | |
| | degree 60%) | | | | | | | | | | | |
| Example 12 | Nylon | 10 μm | PP adhesive | 0.5 | μm | Unstretched | 80 | μm | 92 | A | B | B |
| | | | | | | PP | | | | | | |
| Comparative | Nylon | 25 μm | Polyurethane | 3 | μm | Low-density | 150 | μm | 72 | A | A | C |
| Example 1 | | | | | | PE | | | | | | |
| Comparative | Nylon | 25 μm | Polyurethane | 3 | μm | Low-density | 150 | μm | 73 | A | B | C |
| Example 2 | | | | | | PE | | | | | | |
| Comparative | Nylon | 25 μm | Polyurethane | 3 | μm | Unstretched | 80 | μm | 78 | A | B | C |
| Example 3 | | | | | | PP | | | | | | |
| Comparative | Nylon | 25 μm | PE adhesive | 0.5 | μm | Low-density | 150 | μm | 87 | A | B | C |
| Example 4 | | | | | | PE | | | | | | |

In the table, A indicates the content (mass %) of polyolefin resin in the resin material constituting the laminated sheet.

Using each of the above-mentioned laminated sheets, the ends were heat-welded to form a bag shape, forming an ink storage bag 2. After that, an ink supply member 3 made of high-density polyethylene was attached by heat-sealing to obtain each ink container 1. After storing ink in the ink container, the following evaluations were performed.

The composition of the ink to be evaluated consists of pigment: 7 mass %, solvent: 15 mass %, surfactant: 1 mass %, amino acid: 6 mass %, inorganic material: 3 mass %, water: 68 mass %.

### Durability Test

As a durability test, the ink container 1 was dropped from a height of 90 cm in six directions, and the damage state of the ink storage bag 2 was examined. As a result, if the bag was damaged and the ink inside leaked out, it was rated as “C”, if the ink storage bag 2 was scratched but the ink did not leak out, it was rated as “B”, and if the ink storage bag 2 was not scratched, it was rated as “A”.

The durability is improved when the polypropylene of the protective layer 6 is subjected to both stretching and electron beam treatment, and when the adjustment layer 10 is inserted.

### Barrier Property Test

As a barrier property test, the amount of evaporation of the internal ink was examined after storing it at 60° C. and a relative humidity of 20% or less for two months. As a result, if it was in a state where printing was not possible with the ink ejection apparatus, it was rated as “C”, if it was possible to print but the printed matter changed slightly in color, it was rated as “B”, and if there was no change in color at all, it was rated as “A”.

In this evaluation, particularly good results were obtained at the level where aluminum foil was used for the barrier layer 9.

### Recyclability Test

To determine the recyclabilty of materials, the ink container was washed after removing the ink and then pelletized using an extrusion molding machine. As a result, the ink container was rated as “C” if it could not be pelletized, “B” if it could be pelletized but the strength was less than 50% of that of the virgin material, and “A” if the strength was 50% or more.

In Comparative Examples 1 to 4, the materials could not be pelletized, but in all the Examples, the materials were recyclable. In particular, when aluminum foil was not used or the content of polyolefin resin was high, the material strength was not significantly reduced.

Next, Example 13 will be described. FIG. 5 shows an ink container 1 having two ink supply tubes 11 for uniformly drawing out ink, and a spacer member 12 connected to the ink supply tubes 11 and having two liquid inlet ports at different heights within the ink container 1. In this configuration, ink is supplied from the top and bottom of the bag, so even if there is a sediment in the ink, the ink is sucked evenly from the top and bottom, making it difficult for the ink composition to become biased.

In this embodiment, the laminated sheet 5 in the ink container 1 is the same as in Example 4, and the ink supply tube 11 and the spacer member 12 are made of unstretched polypropylene. As a result, when the ink inside the ink container 1 is used up and the ink container 1 is recycled, the recyclability is significantly improved because all of the constituent materials are made of olefin-based materials.

FIG. 6 shows the configuration of the ink container 1 in Example 14. At least a part of the outer periphery of the ink storage bag 2 is provided with an unbonded area that can hold the laminated sheet, forming a gripping area 13. This makes it possible to more easily wash the inside of the ink container 1 by holding the gripping area 13 and peeling the laminated sheets 5 apart when the ink inside the ink container 1 is used up. The width W of the gripping area 13 is preferably from 2 mm to 20 mm, and more preferably from 5 mm to 10 mm. The presence of the gripping area 13 further improves recyclability.

While the present invention has been described with reference to exemplary embodiments, it is to be understood that the invention is not limited to the disclosed exemplary embodiments. The scope of the following claims is to be accorded the broadest interpretation so as to encompass all such modification and equivalent structures and functions.

This application claims the benefit of Japanese Patent Application No. 2024-077838 filed May 13, 2024, which is hereby incorporated by reference herein its entirety.

What is claimed is:

1. An ink container that stores ink to be ejected by an ink ejection apparatus, the ink container comprising:
an ink storage bag made of a laminated sheet and storing the ink therein; and an ink supply member comprising an ink supply portion for supplying the ink inside the ink storage bag to the ink ejection apparatus, wherein
a resin material constituting the laminated sheet comprises 90 mass % or more of polyolefin resin.

2. The ink container according to claim 1, wherein
the polyolefin resin is a polypropylene resin.

3. The ink container according to claim 1, wherein
the polyolefin resin is a polyethylene resin.

4. The ink container according to claim 1, wherein
the laminated sheet comprises a protective layer,
the protective layer is disposed on an outermost layer of the ink storage bag, and
the protective layer satisfies at least one of conditions that an orientation degree of the protective layer is 60% or more and a gel fraction of the protective layer is 15% or more.

5. The ink container according to claim 4, wherein
the protective layer has a thickness ranging from 10 μm to 150 μm.

6. The ink container according to claim 1, wherein
the laminated sheet comprises a sealing layer,
the sealing layer is disposed on an innermost layer of the ink storage bag,
the sealing layer comprises at least one selected from the group consisting of unstretched polypropylene, medium-density polyethylene, and low-density polyethylene, and
the sealing layer is heat-welded to form the ink storage bag.

7. The ink container according to claim 6, wherein
the sealing layer has a thickness ranging from 30 μm to 200 μm.

8. The ink container according to claim 1, wherein
the laminated sheet comprises an adhesive layer between layers of the laminated sheet,
the adhesive layer comprises at least one selected from the group consisting of a polypropylene resin and a polyethylene resin, and
the adhesive layer comprises a monomer unit corresponding to an unsaturated carboxylic acid and an unsaturated carboxylic acid anhydride as at least one copolymerization component selected from the group consisting of the polypropylene resin and the polyethylene resin.

9. The ink container according to claim 8, wherein
the adhesive layer has a thickness ranging from 0.05 μm to 1.0 μm.

10. The ink container according to claim 1, wherein
the laminated sheet comprises a barrier layer between layers of the laminated sheet, and
the barrier layer comprises at least one selected from the group consisting of aluminum and inorganic oxides.

11. The ink container according to claim 10, wherein
the barrier layer is an aluminum foil or at least one vapor-deposited film selected from the group consisting of aluminum and inorganic oxides,
the aluminum foil has a thickness ranging from 2 μm to 20 μm, and
the vapor-deposited film has a thickness ranging from 1 nm to 150 nm.

12. The ink container according to claim 1, wherein
the laminated sheet comprises an adjustment layer between layers of the laminated sheet, and
the adjustment layer comprises a polyolefin resin that has been subjected to one or both of a stretching treatment and an electron beam treatment.

13. The ink container according to claim 12, wherein
the adjustment layer has a thickness ranging from 10 μm to 100 μm.

14. The ink container according to claim 1, further comprising:
an ink supply tube arranged inside the ink container and connected to the ink supply portion; and
a spacer member connected to the ink supply tube and having a liquid inlet port for introducing the ink inside the ink storage bag to the ink supply portion through the ink supply tube, wherein
the ink supply tube and the spacer member comprise 90 mass % or more of polyolefin resin.

15. The ink container according to claim 1, wherein
the ink container has a gripping area capable of gripping the laminated sheet in at least a part of an outer periphery of the ink storage bag.

16. The ink container according to claim 15, wherein
the gripping area has a width ranging from 2 mm to 20 mm.
